(19) United States
(12) Patent Application Publication
(10) Pub. No.: US 2018/0128964 A1
(43) Pub. Date: May 10, 2018

(54) BACKLIGHT UNIT, FABRICATION METHOD THEREOF, AND DISPLAY DEVICE INCLUDING THE SAME

(71) Applicant: Samsung Display Co., Ltd., Yongin-Si (KR)

(72) Inventors: Kwangsoo BAE, Suwon-si (KR); Jungsuk BANG, Seoul (KR); Minjeong OH, Gimpo-si (KR); Haeju YUN, Hwaseong-si (KR); Donchan CHO, Seongnam-si (KR)

(21) Appl. No.: 15/806,391

(22) Filed: Nov. 8, 2017

(30) Foreign Application Priority Data
Nov. 10, 2016 (KR) 10-2016-0149796

(51) Int. Cl. F21V 8/00

(52) U.S. Cl. CPC G02B 6/0088; G02B 6/0055; G02F 1/134309; G02B 6/0091; G02B 6/0065

(57) ABSTRACT

A backlight unit includes a light source which generates light; a light guide plate which guides the light from the light source and emits guided light through an upper thereof; and an optical member disposed on the upper surface of the light guide plate. The optical member includes: a plurality of first insulating patterns into which the guided light from the upper surface of the light guide plate is incident; and a second insulating layer which covers the first insulating patterns to define an upper surface of the optical member through which light exits toward a display panel. Each of the first insulating patterns includes: a bottom portion extended from the upper surface of the light guide plate; and a sidewall portion upwardly extending from a boundary of the bottom portion, the sidewall portion inclined at an angle relative to the upper surface of the light guide plate.

This application claims priority to Korean Patent Application No. 10-2016-0149796, filed on Nov. 10, 2016, in the Korean Intellectual Property Office, and all the benefits accruing therefrom under 35 U.S.C. § 119, the contents of which in their entirety are herein incorporated by reference.

### BACKGROUND

### (1) Field

The present disclosure relates to a backlight unit, a fabrication method thereof, and a display device including the same.

### (2) Description of the Related Art

In general, a display device includes a display panel, which is configured to display an image using light, and a backlight unit, which is configured to generate the light and provide the light to the display panel. The display panel includes a first substrate with a plurality of pixels, a second substrate provided to face the first substrate, and an image display layer between the first and second substrates. An edge-type backlight unit, which is provided to face a side surface of the display device, is one type of backlight unit.

Transmittance of the light provided from the backlight unit to the display panel is controlled by the image display layer, which is driven by the pixels, and the transmittance of the light is exploited to display an image. A liquid crystal layer, an electrowetting layer, or an electrophoresis layer may be used as the image display layer.

The edge-type backlight unit includes a light source for generating light, a light guide plate, which is used to guide the light provided from the light source toward the display panel and/or in an upward direction, and an optical sheet, which is provided between the light guide plate and the display panel and is used to condense the light transmitting from the light guide plate to the display panel or in the upward direction.

### SUMMARY

One or more embodiment of the invention provides a relatively thin backlight unit, which emits light with improved efficiency, a method of fabricating the backlight unit, and a display device including the backlight unit.

According to an embodiment of the invention, a backlight unit includes a light source which generates light; a light guide plate which guides the light from the light source and emits guided light through an upper thereof facing a display panel which displays an image with the emitted light; and an optical member disposed on the upper surface of the light guide plate to be between the light guide plate and the display panel. The optical member includes: a plurality of first insulating patterns into which the guided light from the upper surface of the light guide plate is incident to the optical member; and a second insulating layer which covers the first insulating patterns to define an upper surface of the optical member through which light exits the optical member toward the display panel. Each of the first insulating patterns includes: a bottom portion extended from the upper surface of the light guide plate; and a sidewall portion upwardly extending from a boundary of the bottom portion, the sidewall portion inclined at an angle relative to the upper surface of the light guide plate.

In some embodiments, a refractive index of each of the first insulating patterns may be higher than that of the light guide plate, and a refractive index of the second insulating layer may be lower than or equal to that of the light guide plate.

In some embodiments, the refractive index of the light guide plate may be about 1.5, the refractive index of the second insulating layer may be about 1.2, and the refractive index of each of the first insulating patterns may be about 1.8.

In some embodiments, each of the first insulating patterns may include an inorganic material, and the second insulating layer may include an organic material.

In some embodiments, the bottom portion may have a circular shape to define a lower surface thereof at the upper surface of the light guide plate. The sidewall portion which upwardly extends from the boundary of the bottom portion may define an outer side surface thereof outwardly and slantingly extended from a boundary of the lower surface of the bottom portion.

In some embodiments, the outer side surface of the sidewall portion may be inclined at an angle of about 60° to about 65° to the upper surface of the light guide plate.

In some embodiments, the first insulating patterns may be arranged in a matrix shape in a plane defined by first and second directions crossing each other, and the lower surface of the bottom portion may be parallel to the plane defined by the first and second directions.

In some embodiments, a maximum height from the lower surface of the bottom portion to an upper surface of the bottom portion in a direction normal to the lower surface of the bottom portion, a maximum diameter of the lower surface of the bottom portion in a direction parallel to the lower surface of the bottom portion, a maximum height from the lower surface of the bottom portion to an upper surface of the sidewall portion in the direction normal to the lower surface of the bottom portion, and a maximum distance between two adjacent ones of the bottom portions in the first or second direction may satisfy a ratio relationship of 1:2:2:4-6.

In some embodiments, a maximum height from the lower surface of the bottom portion to an upper surface of the bottom portion in a direction normal to the lower surface of the bottom portion may be given as about 1 micrometer (μm), a maximum diameter of the lower surface of the bottom portion in a direction parallel to the lower surface of the bottom portion may be given as about 2 μm, a maximum height from the lower surface of the bottom portion to an upper surface of the sidewall portion in the direction normal to the lower surface of the bottom portion may be given as about 2 μm, a maximum distance between two adjacent ones of the bottom portions in the first or second direction may be given as about 4 μm to about 6 μm, and a maximum height from the lower surface of the bottom portion to an upper surface of the second insulating layer in the direction normal to the lower surface of the bottom portion may be given as about 7 μm to about 10 μm.

In some embodiments, a unit area of the upper surface of the light guide plate is about 324 square micrometers (324 μm²) and the first insulating patterns provided on an upper surface of the light guide plate may be arranged at a density of about 4 per 324 μm².

According to an embodiment of the invention, a method of fabricating a backlight unit includes forming a first photoresist layer with a plurality of openings recessed from an upper surface thereof, on a light guide plate which guides light from a light source and emits guided light through an upper thereof facing a display panel which displays an image with the emitted light; forming a first insulating material layer on the upper surface of the light guide plate to cover the first photoresist layer and the openings; removing a portion of the first insulating material layer, which is positioned above the upper surface of the first photoresist layer on the light guide plate, to form a plurality of first insulating patterns in the openings, respectively, into which guided light from the upper surface of the light guide plate is incident; removing the first photoresist layer to maintain the plurality of first insulating patterns on the upper surface of the light guide plate; and forming a second insulating layer on the light guide plate to cover the upper surface of the light guide plate and the first insulating patterns thereon, the second insulating layer defining an upper surface thereof through which light exits toward the display panel. Each of the first insulating patterns includes a bottom portion extended from the upper surface of the light guide plate, and a sidewall portion upwardly extending from a boundary of the bottom portion, the sidewall portion being inclined at an angle to the upper surface of the light guide plate.

According to an embodiment of the invention, a display device includes a display panel which generates the light; a light guide plate which guides the light from the light source and emits guided light through an upper surface thereof toward the display panel; a plurality of first insulating patterns on the upper surface of the light guide plate, into which the guided light from the upper surface of the light guide plate is incident, the first insulating patterns including an inorganic material; and a second insulating layer which covers the first insulating patterns on the upper surface of the light guide plate to define an upper surface of the second insulating layer through which light exits toward the display panel, the second insulating layer including an organic material. Each of the first insulating patterns includes: a bottom portion extended from the upper surface of the light guide plate, the bottom portion defining a lower surface thereof at the upper surface of the light guide plate; and a sidewall portion upwardly extending from a boundary of the bottom portion, the sidewall portion being inclined at an angle relative to the upper surface of the light guide plate to define an outer side surface thereof outwardly and slantingly extended from a boundary of the lower surface of the bottom portion.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a perspective view of an exemplary embodiment of a display device according to the invention.

FIG. 2 is a schematic diagram illustrating an exemplary embodiment of a pixel of FIG. 1.

FIG. 3 is a top plan view illustrating an exemplary embodiment of an optical member of FIG. 1.

FIG. 4 is a perspective view illustrating an exemplary embodiment of a first region ‘A’ of FIG. 3.

FIG. 5 is a cross-sectional view taken along line I-I′ of FIG. 3.

FIG. 6 is a diagram exemplarily illustrating a propagation path of light refracted by an exemplary embodiment of a first insulating pattern of an optical member.

FIGS. 7 to 12 are cross-sectional views illustrating an exemplary embodiment of a method of fabricating an optical member of a display device according to the invention.

FIGS. 13 to 15 are diagrams illustrating cross-sectional shapes of modified exemplary embodiments of first insulating patterns according to the invention.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventions will now be described more fully with reference to the accompanying drawings, in which example embodiments are shown. Example embodiments of the invention may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being related to another element such as being “connected” or “coupled” to another element, it can be directly connected or coupled to the other element or intervening elements may be present. In contrast, when an element is referred to as being related to another element such as being “directly connected” or “directly coupled” to another element, there are no intervening elements present. Like numbers indicate like elements throughout.

As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof

An optical sheet of a backlight unit may include a collection of individual sheets such as a diffusion sheet for diffusing the light, a prism sheet, which is provided on the diffusion sheet to condense the light passing therethrough, and a protection sheet, which is provided on the prism sheet to protect the prism sheet. In general, the optical sheet including the plurality of individual sheets and has a total thickness of about 0.5 millimeter (mm). Due to the presence of the optical sheet within the backlight unit, the display device including such backlight unit may undesirably have an increased thickness.

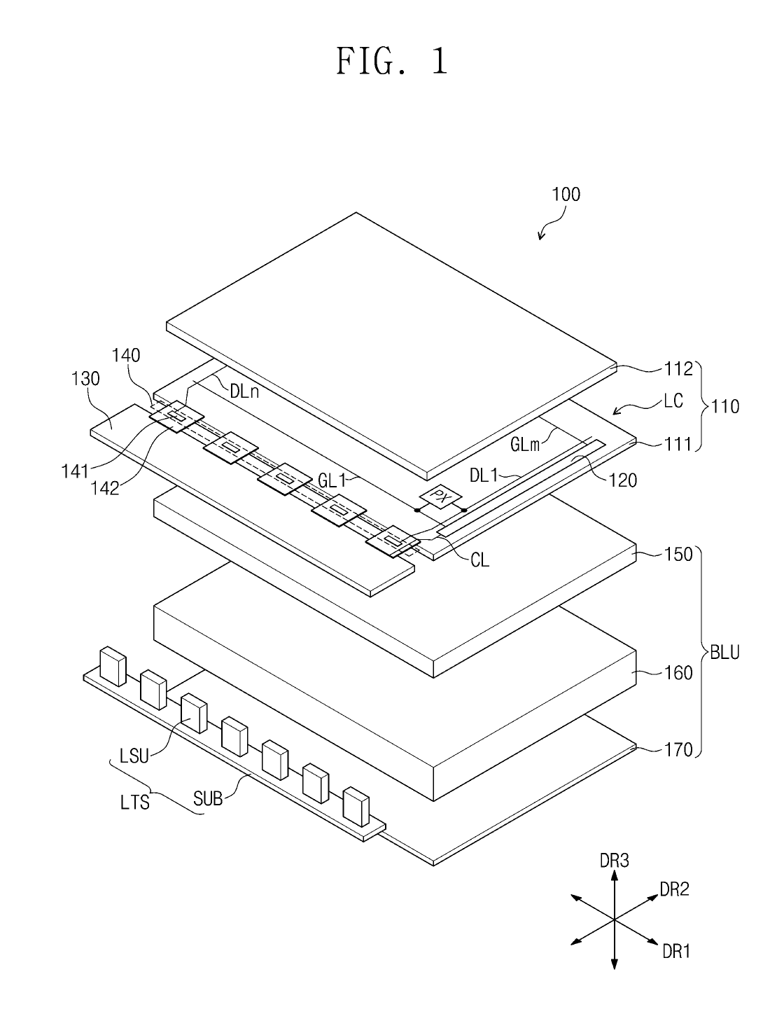

FIG. 1 is a perspective view of an exemplary embodiment of a display device according to the invention.

Referring to FIG. 1, a display device 100 may include a display panel 110, a gate driver 120, a printed circuit board 130, a data driver 140 and a backlight unit BLU. The display panel 110 may have a relatively long side, which lengthwise extends in a first direction DR1, and a relatively short side, which lengthwise extends in a second direction DR2 crossing the first direction DR1. The backlight unit BLU may be configured to generate and condense light and to transmit the light to the display panel 110. The display panel 110 may use the light transmitted from the backlight unit BLU to display an image.

The display panel 110 may include a first (display) substrate 111, a second (display) substrate 112 facing the first substrate 111, and an image display layer such as a liquid crystal layer LC between the first and second substrates 111 and 112. A pixel PX provided in plurality, a plurality of gate lines GL1-GLm, and a plurality of data lines DL1-DLn may be provided in the first substrate 111 such as on a first base substrate thereof, where m and n are natural numbers. Although, for convenience in description, one pixel PX is illustrated in FIG. 1, a plurality of the pixels PX may be provided in the first substrate 111 such as on the first base substrate thereof. For convenience of explanation, reference numerals 111 and 112 may generally indicate a display substrate or the base substrate thereof

The gate lines GL1-GLm and the data lines DL1-DLn may be electrically insulated from each other and may be provided to cross each other. The gate lines GL1-GLm may lengthwise extend in the first direction DR1 and may be connected to the gate driver 120. The data lines DL1-DLn may lengthwise extend in the second direction DR2 and may be connected to the data driver 140.

In an exemplary embodiment, the pixels PX may be respectively provided in regions, which are defined by the gate lines GL1-GLm and the data lines DL1-DLn., but the invention is not limited thereto The pixels PX may be arranged in a matrix shape and may be connected to respective gate lines GL1-GLm and data lines DL1-DLn. The image may be generated and/or displayed with light at the pixels PX, under control of the gate driver 120 and the data drier 140. The pixels PX may be disposed in a display area of the display panel 110, at which the image is displayed. An area of the display panel 110 except for the display area may define a non-display area of the display panel 110 at which the image is not displayed.

The gate driver 120 may be provided at a predetermined area of the first substrate 111 such as on the first base substrate thereof, which is adjacent to one end of the first substrate 111 in the first direction DR1. In an exemplary embodiment of manufacturing a display device, elements and/or layers of the gate driver 120 may be formed at the same time using the same process as that for element and/or layers (e.g., a thin film transistor (“TFT”)) of the pixels PX. The gate driver 120 may be mounted on the first base substrate of the first substrate 110 in an amorphous silicon TFT gate driver circuit (“ASG”) method or an oxide silicon TFT gate driver circuit (“OSG”) method.

However, the invention is not limited thereto, and the gate driver 120 may include a plurality of driver chips that are mounted on a flexible printed circuit board and are connected to the first substrate 111 in a tape carrier package (“TCP”) method. In certain embodiments, the gate driver 120 may be or include one of a plurality of driver chips that are mounted on the first substrate 111 in a chip-on-glass (“COG”) method.

A timing controller (not shown) may be provided on the printed circuit board 130. The timing controller may be an integrated circuit chip, which is mounted on the printed circuit board 130, and may be connected to the gate driver 120 and to the data driver 140. The timing controller may be configured to output a gate control signal, a data control signal, and image data to control operation of the display panel 110, such as the pixels PX thereof

The gate driver 120 may receive the gate control signal from the timing controller through a control line CL. The gate driver 120 may be configured to generate a plurality of gate signals in response to the gate control signal and sequentially output the gate signals. The gate signals are applied to the pixels PX through the gate lines GL1 to GLm in the unit of row. As a result, the pixels PX are driven in the unit of row, to display the image.

The data driver 140 may include a source driving chip 141 provided in plurality and a flexible circuit board 142 provided in plurality. The source driving chips 141 may be mounted on flexible circuit boards 142, respectively. The flexible circuit boards 142 may be connected to a predetermined area of one end of the first substrate 111, when viewed in the second direction DR2, and to the printed circuit board 130 disposed at the one end. In an exemplary embodiment, for example, the data driver 140 may be connected to the first substrate 111 and to the printed circuit board 130 in a tape carrier package (“TCP”) method. However, the invention is not limited thereto, and the source driving chips 141 of the data driver 140 may be mounted on the first substrate 111 in a chip-on-glass (“COG”) method.

The data driver 140 may be configured to receive the image data and/or the data control signal from the timing controller. The data driver 140 may be configured to generate analog data voltages corresponding to the image data in response to the data control signal and then output the analog data voltages. The data voltages may be provided to the pixels PX through the data lines DL1-DLn.

The pixels PX may receive the data voltages through the data lines DL1-DLn, in response to the gate signals provided through the gate lines GL1-GLm. The pixels PX display grayscales corresponding to the data voltages, and thus the image is displayed.

The backlight unit BLU may be an edge-type backlight unit. The backlight unit BLU may include an optical member 150, a light guide plate 160, a light source LTS and a reflection sheet 170. Each of the optical member 150, the light guide plate 160, and the reflection sheet 170 may be provided to have a relatively long side parallel to the first direction DR1 and a relatively short side parallel to the second direction DR2.

The optical member 150 may be provided below the display panel 110, the light guide plate 160 may be provided below the optical member 150, and the reflection sheet 170 may be provided below the light guide plate 160. The light source LTS may define a length thereof extended in the first direction DR1 and may be provided adjacent to a side surface of the light guide plate 160 in the second direction DR2.

The light guide plate 160 may include glass, but the invention is not limited thereto. In an exemplary embodiment, for example, the light guide plate 160 may be formed of or include a plastic material (e.g., polymethylmethacrylate (“PMMA”)).

The light guide plate 160 includes a light exiting surface from which light exits the light guide plate 160, a rear surface opposite to the light exiting surface, and side surfaces which connect the light exiting surface and the rear surface to each other. A side surface of the light guide plate 160 adjacent to the light source LTS in the second direction DR2 may be used as a light-incident surface, and light generated in the light source LTS may be incident into the light guide plate 160 through the light-incident surface. The light guide plate 160 may be configured to guide the light, which is incident from the light source LTS, toward the display panel 110 or in an upward direction, where the upward direction may be perpendicular to both of the first and second directions DR1 and DR2.

The light source LTS may include a light source substrate SUB having a length extending in the first direction DR1 and a light source unit LSU provided in plurality mounted on the light source substrate SUB. The light source units LSU may be provided to be spaced apart from each other along a length of the light source substrate SUB, in the first direction DR1 with a uniform distance therebetween. The light source units LSU may be provided to face the side surface of the light guide plate 160 in the second direction DR2. The light source units LSU may be configured to emit light, and the light emitted from the light source units LSU may be incident into the side surface (e.g., the light-incident surface) of the light guide plate 160.

The reflection sheet 170 may be configured to reflect a part of the light, which propagates toward and through the rear surface of the light guide plate 160, back toward the display panel 110 or in the upward direction.

When the light, which is incident from the light guide plate 160, propagates in the upward direction, the optical member 150 may be configured to condense the light. The optical member 150 may also be configured to allow the light to propagate toward the display panel 110 or in the upward direction with uniform brightness distribution.

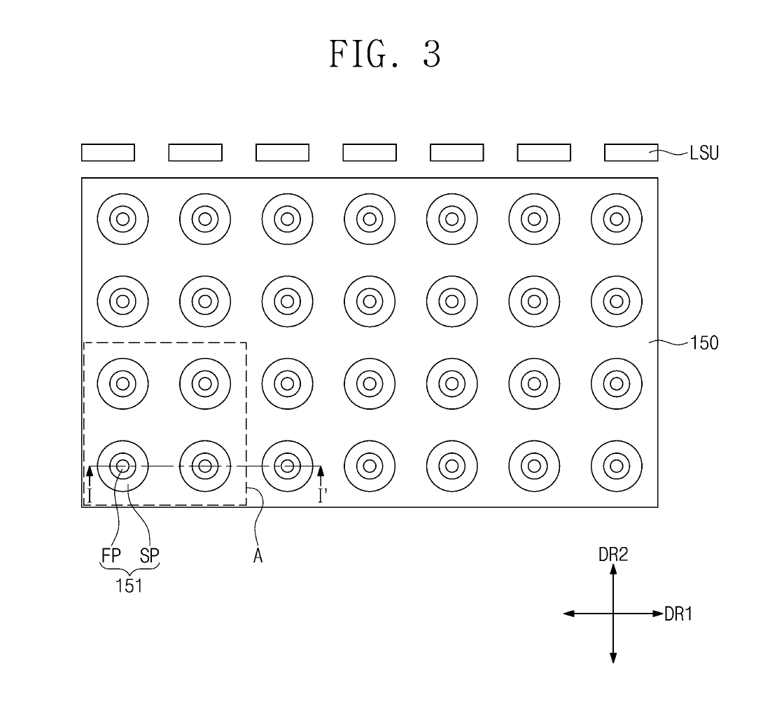

Hereinafter, the upward direction perpendicular to both of the first and second directions DR1 and DR2 will be referred to as a third direction DR3 or a normal direction. A thickness of the display device 100 or components thereof is taken along the third direction DR3. When measured in the third direction DR3, the optical member 150 may have a total thickness ranging from about 7 micrometers (μm) to about 10 μm. The detailed structure of the optical member 150 will be described in more detail with reference to FIGS. 3 to 5.

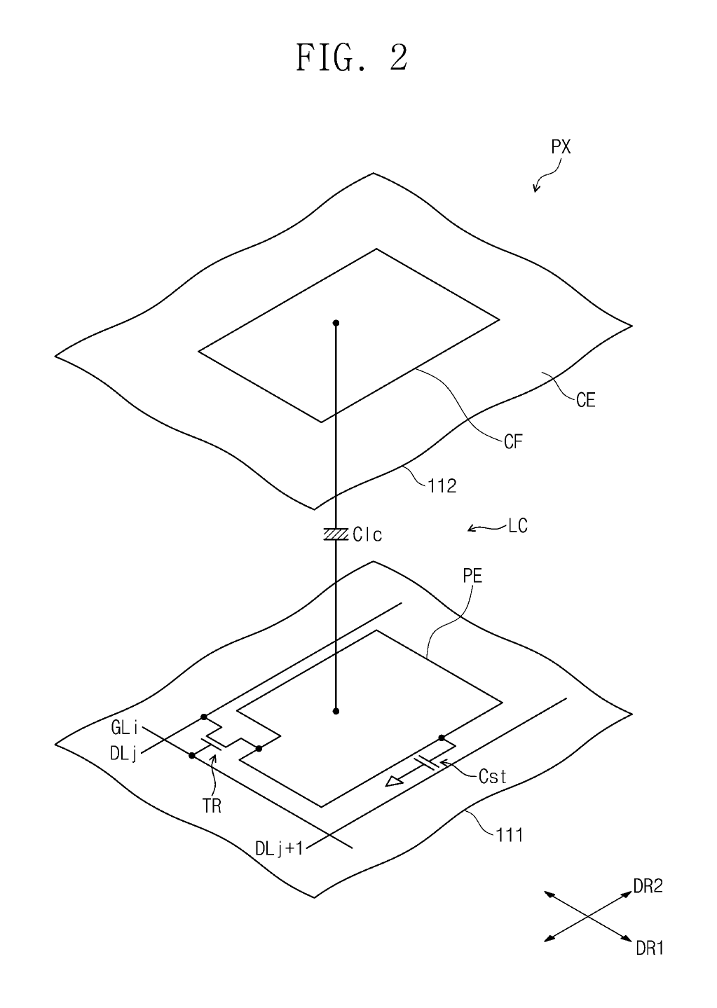

FIG. 2 is a schematic diagram illustrating an exemplary embodiment of the pixel of FIG. 1.

For convenience in description, FIG. 2 illustrates a pixel PX connected to the gate line GLi and the data line DLj. Although not shown, other pixels of the display panel 110 may be configured to have the same structure as that of the pixel PX shown in FIG. 2.

Referring to FIG. 2, the pixel PX may include a switching element such as a transistor TR connected to the gate line GLi and the data line DLj among data lines DLj and DLj+1, a liquid crystal capacitor Clc connected to the transistor TR, and a storage capacitor Cst connected in parallel to the liquid crystal capacitor Clc, where i and j are natural numbers. In certain embodiments, the storage capacitor Cst may be omitted.

The transistor TR may be provided in the first substrate 111 such as on a base substrate thereof. The transistor TR may include a gate electrode connected to the gate line

GLi, a source electrode connected to the data line DLj, and a drain electrode connected to the liquid crystal capacitor Clc and the storage capacitor Cst.

The liquid crystal capacitor Clc may include a pixel electrode PE provided in the first substrate 111, a common electrode CE provided in the second substrate 112 such as on a second base substrate thereof, and the liquid crystal layer LC disposed between the pixel and common electrodes PE and CE. The liquid crystal layer LC may serve as a dielectric layer. The pixel electrode PE may be connected to the drain electrode of the transistor TR.

Although FIG. 2 illustrates an example in which the pixel electrode PE has a non-slit structure, the pixel electrode PE may have a slit structure including a cross-shaped stem portion and a plurality of branches which extend radially from the stem portion.

The common electrode CE may be provided to cover substantially the entirety of the second substrate 112, but the invention is limited thereto. In an exemplary embodiment, for example, the common electrode CE may be provided in the first substrate 111 along with the pixel electrode PE. In this case, at least one of the pixel and common electrodes PE and CE may be configured to include a slit-shaped pattern.

The storage capacitor Cst may include the pixel electrode PE, a storage electrode (not shown) diverging from a storage line (not shown), and an insulating layer disposed between the pixel electrode PE and the storage electrode. The storage line may be provided in the first substrate 111 such as on the first substrate thereof In an exemplary embodiment of manufacturing a display device, the storage line and the gate lines GL1-GLm may be simultaneously formed such as from a same material layer, to be disposed in a same layer of the first substrate 111 among layers on the first base substrate thereof. The storage electrode may be partially overlapped with the pixel electrode PE.

The pixel PX may further include a color filter CF, which is configured to display one of red, green and blue colors. In example embodiments, the color filter CF may be provided in the second substrate 112 such as on the second base substrate thereof, as shown in FIG. 2, but the invention is not limited thereto. In an exemplary embodiment, for example, in certain embodiments, the color filter CF may be provided in the first substrate 111.

The transistor TR may be turned on in response to a gate signal applied to the gate line GLi. If a data voltage is applied to the transistor TR via the data line DLj, the data voltage may be applied to the pixel electrode PE of the liquid crystal capacitor Clc via the turned-on transistor TR. In some embodiments, a common voltage may be applied to the common electrode CE.

Due to a difference in voltage level between the data voltage and the common voltage, an electric field may be produced between the pixel and common electrodes PE and CE. The electric field between the pixel and common electrodes PE and CE may be used to control motion or orientation of liquid crystal molecules in the liquid crystal layer LC. The change in motion or orientation of the liquid crystal molecules may be controlled to adjust optical transmittance of the liquid crystal layer LC, and this may be used to display an image.

A storage voltage of a constant level may be applied to the storage line, but the invention is not limited thereto. In an exemplary embodiment, for example, the common voltage may be applied to the storage line. The storage capacitor Cst compensates for the lack of the charging rate of the liquid crystal capacitor Clc.

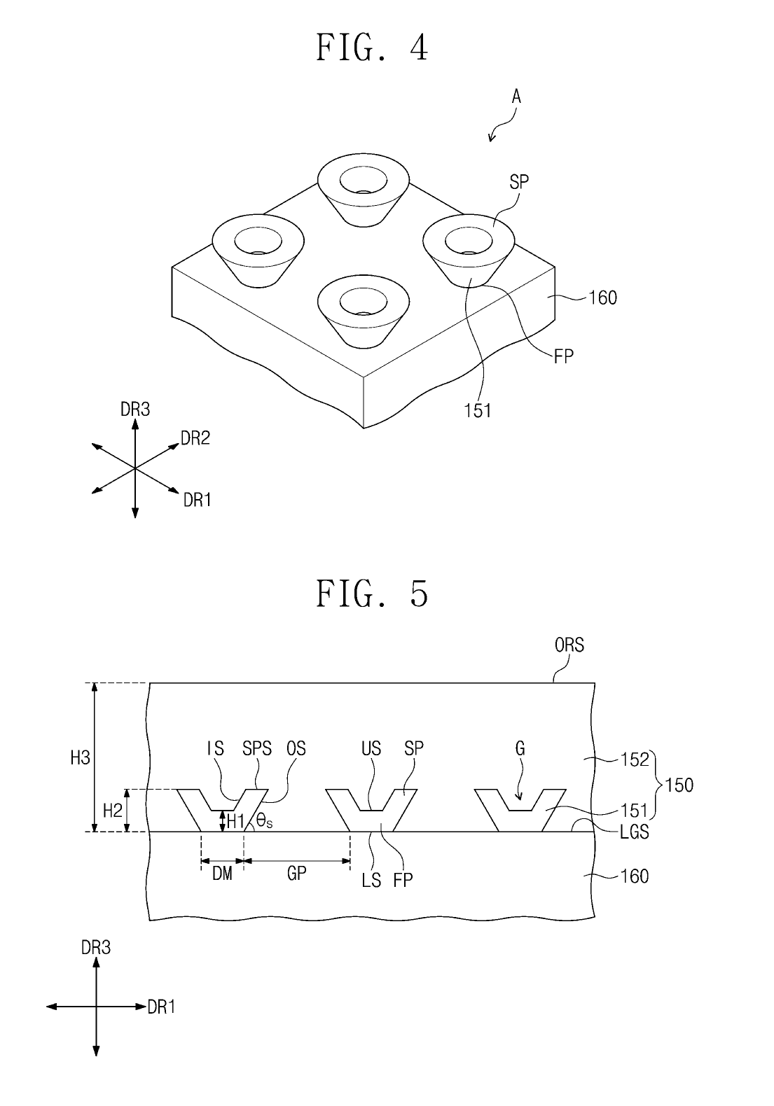

FIG. 3 is a top plan view illustrating an exemplary embodiment of the optical member of FIG. 1. FIG. 4 is a perspective view illustrating an exemplary embodiment of a first region ‘A’ of FIG. 3. FIG. 5 is a cross-sectional view taken along line I-I′ of FIG. 3.

For convenience in description, in FIG. 4, a second insulating layer 152 shown in FIG. 5 is omitted.

Referring to FIGS. 3, 4 and 5, the optical member 150 may include a first insulating pattern 151 provided in plurality on the light guide plate 160, and a second insulating layer 152, which is provided on the light guide plate 160 to surround and cover the first insulating patterns 151. The first insulating pattern 151 may be a discrete member within the second insulating layer 152. The first insulating patterns 151 may be arranged in the first and second directions DR1 and DR2 to form a matrix shaped arrangement, but the invention is not limited thereto. In an exemplary embodiment, for example, the first insulating patterns 151 may be arranged in an irregular or random manner along the first and/or second directions DR1 and DR2.

Each of the first insulating patterns 151 may have a refractive index that is higher than that of the light guide plate 160, and the second insulating layer 152 may have a refractive index that is lower than or equal to that of the light guide plate 160. In some embodiments, the light guide plate 160 may be configured to have the refractive index of about 1.5, the second insulating layer 152 may be configured to have the refractive index of about 1.2, and each of the first insulating patterns 151 may be configured to have the refractive index of about 1.8.

The light guide plate 160 may be formed of or include glass, each of the first insulating patterns 151 may be formed of or include an inorganic material, and the second insulating layer 152 may be formed of or include an organic material. In an exemplary embodiment, for example, each of the first insulating patterns 151 may be formed of or include an inorganic material (e.g., silicon nitride (SiNx)).

The first insulating patterns 151 may be shaped like a discrete bowl. As the bowl shape, for example, the first insulating patterns 151 may include a bottom portion FP, and a sidewall portion SP, which is upwardly extended from a boundary of the bottom portion FP and is inclined at an angle to an upper surface LGS of the light guide plate 160. The upper surface LGS may be a surface of the light guide plate 160 that is parallel to both of the first and second directions DR1 and DR2. The upper surface LGS may be the light exiting surface of the light guide plate 160.

The bottom portion FP may have a circular shape in the top plan view, but the invention is not limited thereto. In an exemplary embodiment, for example, the bottom portion FP may have one of various planar shapes including polygonal shapes (e.g., triangle, rectangle, or pentagon) or an elliptical shape. A recessed region G, which is defined by the bottom portion FP and the sidewall portion SP, may have a reversed trapezoidal shape in cross-section. The sidewall portion SP may have a substantially constant width. The width may be taken parallel to the upper surface LGS of the light guide plate 160 at various positions along the sidewall portion SP.

The sidewall portion SP may include inner and outer side surfaces IS and OS, which are provided to face each other. An outer surface of the overall first insulating pattern 151 may be defined by outer surfaces of the sidewall portion SP and the flat bottom portion FP which are coplanar with each other. The outer side surface OS of the sidewall portion SP may have an inclined surface that is outwardly and slantingly extended from a boundary of a lower surface LS of the bottom portion FP. The outer side surface OS of the sidewall portion SP may be inclined at an angle θs to the upper surface LGS of the light guide plate 160, and in some embodiments, the angle θs may range from about 60 degrees (°) to about 65°.

The lower surface LS may be a surface of the bottom portion FP that is disposed in a plane parallel to a plane defined in both of the first and second directions DR1 and DR2, similar to the upper surface LGS of the light guide plate 160. The lower surface LS may be defined where the first insulating patter 151 interfaces with the light guide plate 160. A direction perpendicular to the lower surface LS of the bottom portion FP may be the third direction DR3.

Hereinafter, the term ‘first height H1’ will be used to refer to a distance from the lower surface LS of the bottom portion FP to an upper surface US of the bottom portion FP, which is measured in the third direction DR3. The term ‘second height H2’ will be used to refer to a distance from the lower surface LS of the bottom portion FP to an upper surface SPS of the sidewall portion SP at a distal end thereof, which is measured in the third direction DR3. The term ‘third height H3’ will be used to refer to a total thickness of the optical member 150 or to a distance from the lower surface LS of the bottom portion FP to an upper surface ORS of the second insulating layer 152, which is measured in the third direction DR3. The heights may be maximum distances between the respective surfaces described above. Light may exit from the optical member 150 through the upper surface ORS of the second insulating layer 152.

The first height H1, a diameter DM of the lower surface LS of the bottom portion FP, the second height H2, and a distance GP between two adjacent ones of the bottom portions FP in the first or second direction DR1 and/or DR2 may be given as a ratio relationship of 1:2:2:4-6. The diameter DM and the distance GP may be maximum distances between the respective elements described above.

In an exemplary embodiment, for example, when the first height H1 is about 1 μm, the second height H2, the diameter DM and the distance GP may be given as about 2 μm, about 2 μm and about 4 μm to 6 μm. The third height H3, as the thickness of the optical member 150, may be given as about 7 μm to about 10 μm.

A conventional optical sheet including a collection of individual sheets such as a diffusion sheet, a prism sheet and a protection sheet may have a total thickness of 0.5 mm, whereas the optical member 150 according to one or more embodiment of the invention may have a total thickness of about 7 μm to about 10 μm. That is, the optical member 150 according to one or more embodiment of the invention can be formed to be thinner than the conventional optical sheet, such that an overall thickness of the display device 100 including such thinner optical member is reduced.

A first region A shown in FIG. 3 may illustrate an example of a unit area of the upper surface LGS of the light guide plate 160. In some embodiments, a planar area of the first region A or the unit area may be 324 μm², and the number of the first insulating patterns 151 to be arranged on the first region A or the unit area of the upper surface LGS of the light guide plate 160, may be 4. That is, the first insulating patterns 151 provided on the upper surface LGS of the light guide plate 160 may be arranged to have a number density of 4 per 324 square micrometers (4/324 μm²).

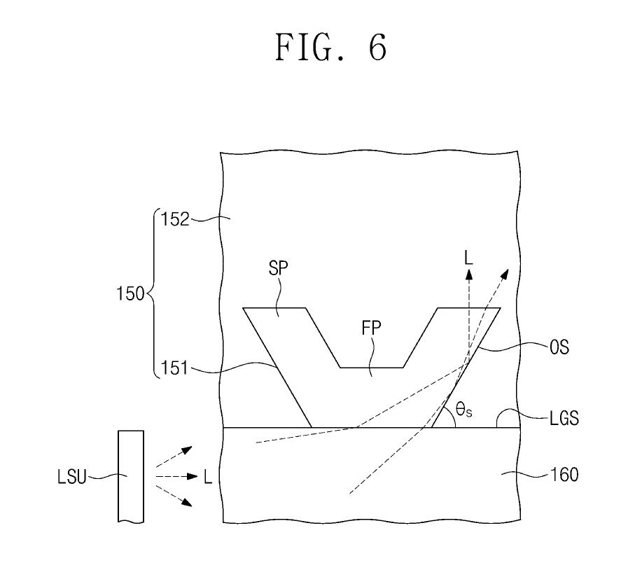

FIG. 6 is a diagram exemplarily illustrating a propagation path of light refracted by an exemplary embodiment of a first insulating pattern of an optical member.

For convenience in description and illustration, only one of the first insulating patterns 151 is illustrated in FIG. 6, but the light refraction in the first insulating pattern 151 shown in FIG. 6 may occur in others among a plurality of the first insulating patterns 151.

Referring to FIG. 6, light L generated in the light source unit LSU and emitted therefrom may be provided into the light guide plate 160 and then may be guided by the light guide plate 160 to be emitted from the light guide plate 160 in an upward direction to be emitted from the light guide plate 160 through the upper surface LGS thereof. In some embodiments, the light guide plate 160 may have a refractive index less than that of the first insulating pattern 151, and thus, the light L provided into the light guide plate 160 may be refracted at an interface between the first insulating pattern 151 and the light guide plate 160 and may propagate into the first insulating pattern 151.

In the case where the refractive index of the first insulating pattern 151 is higher than that of the second insulating layer 152, the light L propagating into the first insulating pattern 151 may be totally reflected by the outer side surface OS of the sidewall portion SP, which is inclined at the angle θs to the upper surface LGS of the light guide plate 160, and may propagate in the upper direction. That is, the optical member 150 may be used to condense the light L propagating from the light guide plate 160 toward the display panel 110 or in the upper direction or to increase an intensity of the light L.

The greater a total thickness of a structure located on a propagation path of light, the higher the optical loss. Since a conventional optical sheet including a collection of individual sheets such as a diffusion sheet, a prism sheet and a protection sheet is relatively thicker than one or more embodiment of the optical member 150 according to the invention, the optical loss in the conventional optical sheet may be increased. By contrast, since one or more embodiment of the optical member 150 has a total thickness less than 1/10 of the total thickness of the conventional optical sheet, the optical loss in the optical member 150 can be greatly reduced.

At the outer side surface OS of the first insulating pattern 151, a fraction of the light L, which is totally reflected by the outer side surface OS and propagates in the upward direction, may be larger at a portion of the outer side surface OS spaced apart from the light source unit LSU than at another portion of the outer side surface OS closer or adjacent to the light source unit LSU. Although a portion of the light propagating toward the another portion of the outer side surface OS closer or adjacent to the light source unit LSU does not propagate in the upper direction or is lost, the amount of such loss may be very small when compared with light propagating in the upward direction over an entirety of the optical sheet. Thus, one or more embodiment of the optical member 150 may have light emitting efficiency that is higher than that of the conventional optical sheet.

Thus, according to one or more embodiment of the invention, light emitting efficiency of the backlight unit BLU or the display device 100 may be increased by including the first insulating patterns 151 in the optical member 150. In addition, due to the relatively slimmer structure of the optical member 150 as compared to a thickness of a conventional optical sheet, the overall thickness of the display device 100 may be reduced.

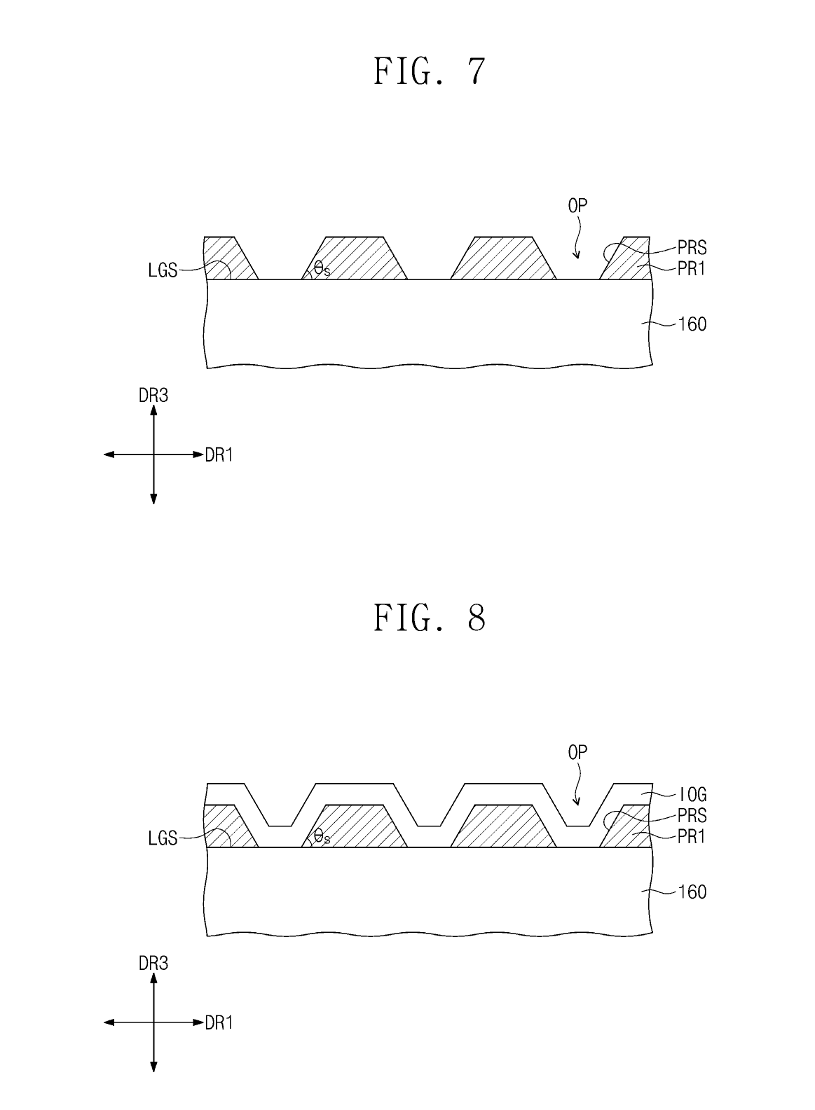

FIGS. 7 to 12 are cross-sectional views illustrating an exemplary embodiment of a method of fabricating an optical member of a display device according to the invention.

For convenience in description and illustration, the fabrication method in FIGS. 7 to 12 will be described with reference to cross-sections corresponding to line I-I′ in FIG. 3, similar to the cross-sectional view of FIG. 5.

Referring to FIG. 7, a first photoresist layer PR1 with a plurality of openings OP defined therein may be provided on the light guide plate 160. Each of the openings OP may define a position and a shape of a corresponding one of the first insulating patterns 151 to be subsequently formed. That is, the openings OP may be essentially used as a mold for forming the first insulating patterns 151.

Although not shown, a photo-sensitive resin material or a photoresist material layer may be formed on the light guide plate 160, and then, a photomask may be placed on the photo-sensitive resin to expose regions of the photo-sensitive resin material corresponding to the openings OP. Thereafter, an exposure process may be performed on the regions of the photo-sensitive resin material corresponding to the openings OP, and a developing solution may be used to selectively remove the exposed regions of the photo-sensitive resin material. As a result, the first photoresist layer PR1 with the openings OP may be formed from the photo-sensitive resin material. The upper surface LGS of the light guide plate 160 may be exposed at the openings OP. In some embodiments, a positive-type photoresist material layer may be used as the photo-sensitive resin material.

The first photoresist layer PR1 may have a side surface PRS defining the openings OP. The side surface PRS may be formed inclined at an angle θₛ relative to the upper surface LGS of the light guide plate 160.

Referring to FIG. 8, a first insulating material layer IOG may be formed on the light guide plate 160 to cover the first photoresist layer PR1 and the openings OP. The first insulating material layer IOG may be formed of or include an inorganic insulating layer. As an example, the first insulating material layer IOG may be deposited to conformally cover the first photoresist layer PR1 and the openings OP and to have a (maximum) thickness of about 1 μm. The thickness may be taken in a direction normal to a respective surface of the side surface PRS or of the light guide plate 160 exposed at the openings OP. The first insulating material layer IOG TOG may be formed on an entirety of the light guide plate 160.

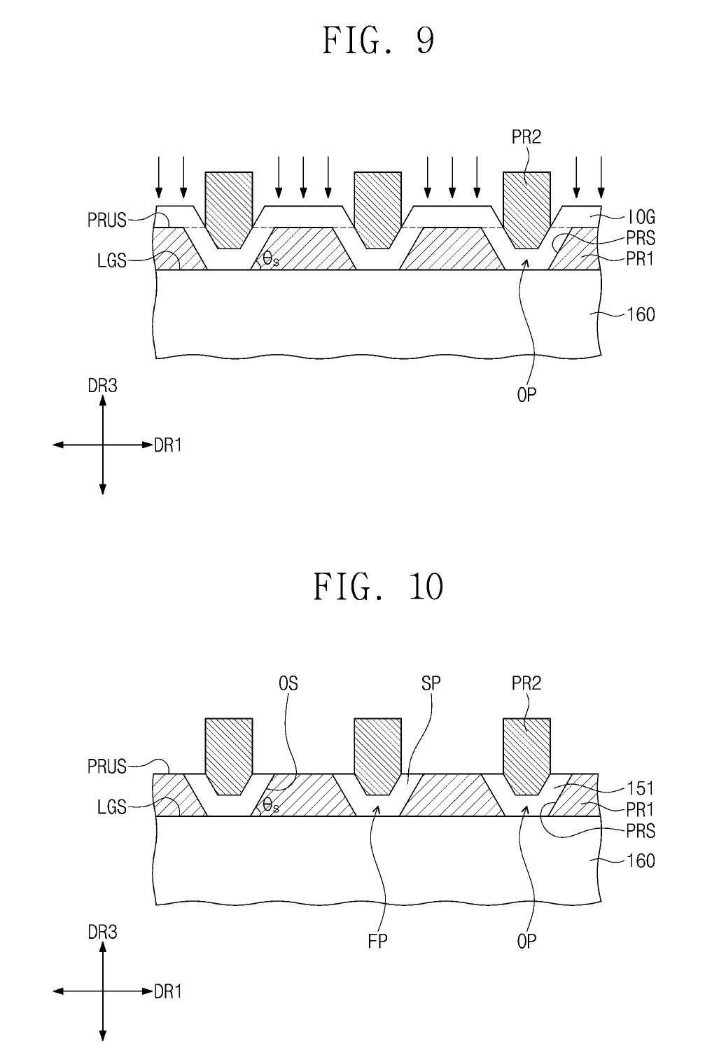

Referring to FIG. 9, second photoresist layers or patterns PR2 may be formed on an upper surface of the first insulating material layer IOG. In some embodiments, the second photoresist layers PR2 may be formed to cover portions of the upper surface of the first insulating material layer IOG positioned at a level equal to an upper surface PRUS of the first photoresist layer PR1 from which the openings OP are recessed towards the light guide plate 160. Portions of the first insulating material layer IOG are exposed between the second photoresist patterns PR2. That is, a boundary or edge of the second photoresist patterns PR2 is disposed to meet the first insulating material layer IOG at the upper surface PRUS of the first photoresist layer PR1. The boundary or edge is defined at a maximum width dimension of the second photoresist patterns PR2.

The first insulating material layer IOG may be etched (refer to downward arrows in FIG. 9) using the second photoresist layers PR2 as an etch mask. In an exemplary embodiment, for example, the etching of the first insulating material layer IOG may be performed by a dry etching process to remove portions of the first insulating material layer IOG exposed by the second photoresist layers PR2. A variety of known dry etching technologies may be used for the etching of the first insulating material layer IOG.

A thickness of the first insulating material layer IOG to be removed in the dry etching process may be in proportion to a process time of the dry etching process. In the case, where the first insulating material layer IOG, which is an inorganic insulating material layer, is deposited to a thickness of 1 μm, the first insulating material layer IOG on the upper surface PRUS of the first photoresist layer PR1 may have a thickness of 1 μm.

In the case where the dry etching process is performed for 120 seconds, portions of the first insulating material layer IOG extended from the topmost surface of the first insulating material layer IOG may be removed by a vertical thickness of 1 μm taken in a direction normal to the upper surface LGS of the light guide plate 160. Here, the topmost surface of the first insulating material layer IOG may be the upper portion of the first insulating material layer IOG that is located between the second photoresist layers PR2 and is extended parallel to the upper surface LGS of the light guide plate 160, e.g., above the upper surface PRUS of the first photoresist layer PR1. Thus, portions of the first insulating material layer IOG located at a level higher than (e.g., above) the upper surface PRUS of the first photoresist layer PR1 may be removed.

Referring to FIG. 10, since the portions of the first insulating material layer IOG higher than the upper surface PRUS of the first photoresist layer PR1 are removed, a plurality of the discrete first insulating patterns 151 may be formed in the openings OP, respectively. Since the side surface PRS of the first photoresist layer PR1 is inclined at the angle θₛ relative to the upper surface LGS of the light guide plate 160, the outer side surface OS of the sidewall portion SP of each of the first insulating patterns 151 may also be inclined at the angle θₛ relative to the upper surface LGS of the light guide plate 160.

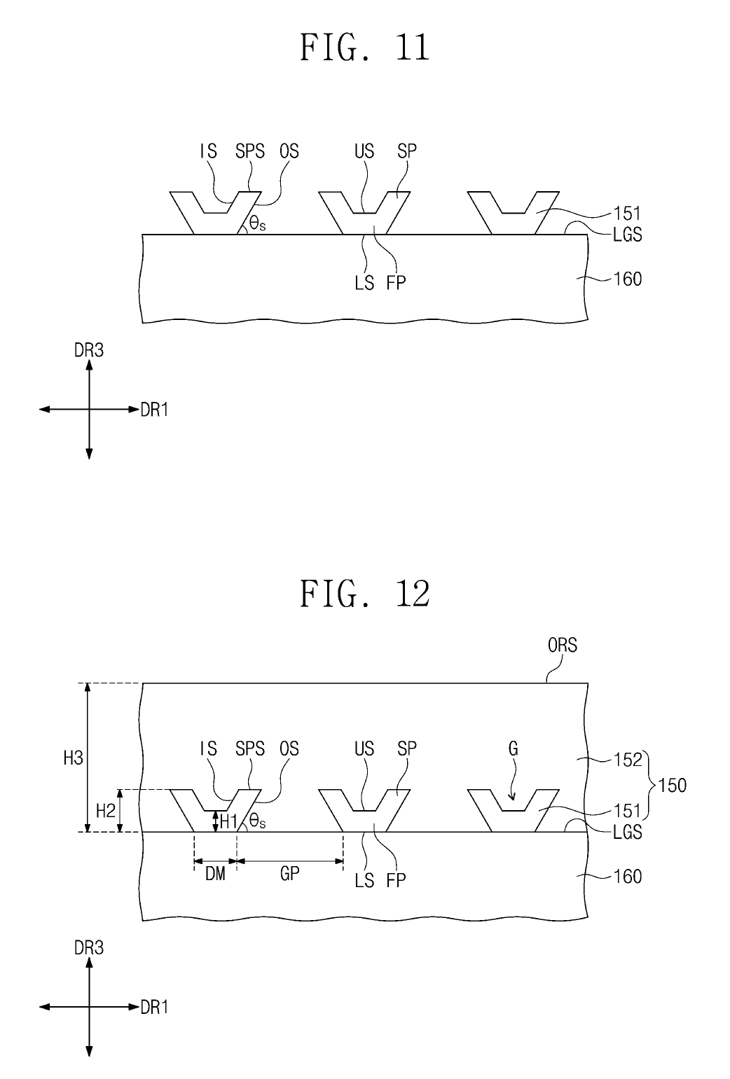

Referring to FIGS. 11 and 12, the first and second photoresist layers PR1 and PR2 may be removed, and thus, the first insulating patterns 151 may remain on the light guide plate 160. The second insulating layer 152 may be formed on the light guide plate 160 to cover the first insulating patterns 151, and thus, the optical member 150 may be fabricated. The second insulating layer 152 may be formed by a second insulating material layer formed on the light guide plate 160 to cover the first insulating patterns 151 and exposed portions of the light guide plate 160 therebetween. Light may exit from the optical member 150 through the upper surface ORS of the second insulating layer 152.

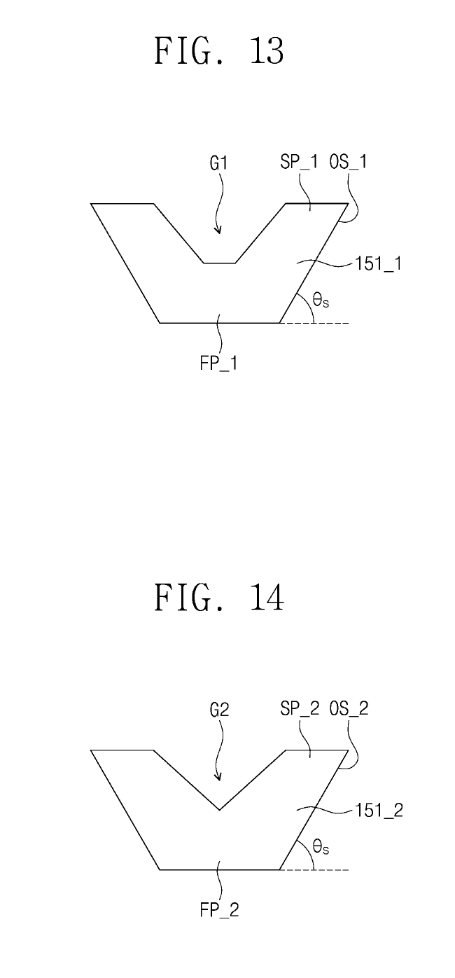

FIGS. 13 to 15 are diagrams illustrating cross-sectional shapes of modified exemplary embodiments of first insulating patterns according to the invention.

Referring to FIG. 13, a first insulating pattern 151_1 may have a bottom portion FP_1 and a sidewall portion SP_1 together defining a recessed region G1. In some embodiments, the recessed region G1 may be formed to have a reversed trapezoidal cross-section. The sidewall portion SP_1 may have an increasing width in a downward direction toward the bottom portion FP_1, and an outer side surface OS_1 of the sidewall portion SP_1 may be inclined at an angle θₛ to the upper surface LGS of the light guide plate 160. The width is taken in a direction parallel to the upper surface LGS of the light guide plate 160.

Referring to FIG. 14, a first insulating pattern 151_2 may have a bottom portion FP_2 and a sidewall portion SP_2 defining a recessed region G2. In some embodiments, the recessed region G2 may have a V-shaped cross-section. The sidewall portion SP_2 may have an increasing width in a downward direction, and an outer side surface OS_2 of the sidewall portion SP_2 may be inclined at an angle θₛ to the upper surface LGS of the light guide plate 160. Portions of the inner surface (refer to IS in FIG. 5) meet each other to form the V-shaped cross-section, such that no portion of the bottom portion FP_2 is exposed at the recessed region G2. The width is taken in a direction parallel to the upper surface LGS of the light guide plate 160.

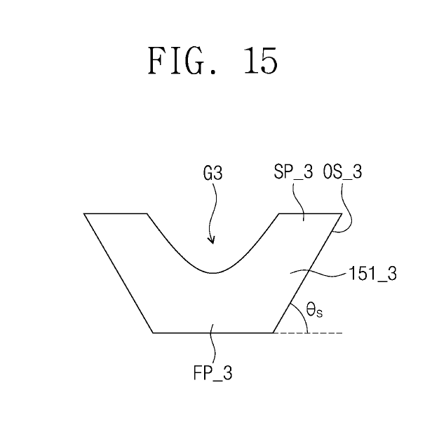

Referring to FIG. 15, a first insulating pattern 151_3 may have a bottom portion FP_3 and a sidewall portion SP_3 defining and a recessed region G3 In some embodiments, the recessed region G3 may be formed to have a concavely rounded cross-section. An outer side surface OS_3 of the sidewall portion SP_3 may be inclined at an angle θₛ to the upper surface LGS of the light guide plate 160. Portions of the inner surface (refer to IS in FIG. 5) meet each other to form the concavely rounded cross-section, such that no portion of the bottom portion FP_3 is exposed at the recessed region G3. The width is taken in a direction parallel to the upper surface LGS of the light guide plate 160.

According to one or more embodiment of the invention, a backlight unit of a display device may include a discrete optical structure within an optical member, which is configured to condense light transmitting in an upward direction. Thus, the optical member including the discrete optical structure may have a relatively slim structure and may allow light emitting efficiency of the backlight unit to be increased. As a result, a total thickness of the display device including such backlight unit may be reduced.

While exemplary embodiments of the invention have been particularly shown and described, it will be understood by one of ordinary skill in the art that variations in form and detail may be made therein without departing from the spirit and scope of the attached claims.

What is claimed is:

1. A backlight unit, comprising:
a light source which generates light;
a light guide plate which guides the light from the light source and emits guided light through an upper thereof facing a display panel which displays an image with the emitted light; and
an optical member disposed on the upper surface of the light guide plate to be between the light guide plate and the display panel, the optical member comprising:
a plurality of first insulating patterns into which the guided light from the upper surface of the light guide plate is incident to the optical member; and
a second insulating layer which covers the first insulating patterns to define an upper surface of the optical member through which light exits the optical member toward the display panel,
wherein each of the first insulating patterns comprises:
a bottom portion extended from the upper surface of the light guide plate; and
a sidewall portion upwardly extending from a boundary of the bottom portion, the sidewall portion inclined at an angle relative to the upper surface of the light guide plate.

2. The backlight unit of claim 1, wherein
a refractive index of each of the first insulating patterns is higher than that of the light guide plate, and
a refractive index of the second insulating layer is lower than or equal to that of the light guide plate.

3. The backlight unit of claim 2, wherein the refractive index of the light guide plate is about 1.5, the refractive index of the second insulating layer is about 1.2, and the refractive index of each of the first insulating patterns is about 1.8.

4. The backlight unit of claim 1, wherein
each of the first insulating patterns further comprises an inorganic material, and
the second insulating layer comprises an organic material.

5. The backlight unit of claim 1, wherein
the bottom portion of each of the first insulating patterns has a circular shape, the bottom portion defining a lower surface thereof at the upper surface of the light guide plate, and
the sidewall portion which upwardly extends from the boundary of the bottom portion defines an outer side surface thereof outwardly and slantingly extended from a boundary of the lower surface of the bottom portion.

6. The backlight unit of claim 5, wherein the outer side surface of the sidewall portion is inclined at an angle of about 60° to about 65° relative to the upper surface of the light guide plate.

7. The backlight unit of claim 5, wherein
the first insulating patterns are arranged in a matrix shape in a plane defined by first and second directions crossing each other, and
the lower surface of the bottom portion is parallel to the plane defined by the first and second directions.

8. The backlight unit of claim 7, wherein a maximum height from the lower surface of the bottom portion to an upper surface of the bottom portion in a direction normal to the lower surface of the bottom portion, a maximum width of the lower surface of the bottom portion in a direction parallel to the lower surface of the bottom portion, a maximum height from the lower surface of the bottom portion to an upper surface of the sidewall portion in the direction normal to the lower surface of the bottom portion, and a maximum distance between two adjacent bottom portions in the first or second direction satisfy a ratio relationship of 1:2:2:4-6.

9. The backlight unit of claim 7, wherein
a maximum height from the lower surface of the bottom portion to an upper surface of the bottom portion in a direction normal to the lower surface of the bottom portion is about 1 micrometer,
a maximum width of the lower surface of the bottom portion in a direction parallel to the lower surface of the bottom portion is about 2 micrometers,
a maximum height from the lower surface of the bottom portion to an upper surface of the sidewall portion in the direction normal to the lower surface of the bottom portion is about 2 micrometers,
a maximum distance between two adjacent bottom portions in the first or second direction is about 4 micrometers to about 6 micrometers, and
a maximum height from the lower surface of the bottom portion to an upper surface of the second insulating layer in the direction normal to the lower surface of the bottom portion is about 7 micrometers to about 10 micrometers.

10. The backlight unit of claim 1, wherein
a unit area of the upper surface of the light guide plate is about 324 square micrometers, and
the first insulating patterns are arranged on the upper surface of the light guide plate at a density of about 4 per 324 square micrometers.

11. The backlight unit of claim 1, wherein the sidewall portion and the bottom portion of each of the first insulating layer patterns respectively define recess regions of the first insulating layer patterns, the recess regions each having a reversed trapezoidal cross-section, a V-shaped cross-section or a concavely rounded cross-section.

12. A method of fabricating a backlight unit, comprising:
forming a first photoresist layer with a plurality of openings recessed from an upper surface thereof, on a light guide plate which guides light from a light source and emits guided light through an upper thereof facing a display panel which displays an image with the emitted light;
forming a first insulating material layer on the upper surface of the light guide plate to cover the first photoresist layer and the openings;
removing a portion of the first insulating material layer, which is positioned above the upper surface of the first photoresist layer on the light guide plate, to form a plurality of first insulating patterns in the openings, respectively, into which guided light from the upper surface of the light guide plate is incident;
removing the first photoresist layer to maintain the plurality of first insulating patterns on the upper surface of the light guide plate; and
forming a second insulating layer on the light guide plate to cover the upper surface of the light guide plate and the first insulating patterns thereon, the second insulating layer defining an upper surface thereof through which light exits toward the display panel,
wherein each of the first insulating patterns comprises:
a bottom portion extended from the upper surface of the light guide plate; and
a sidewall portion upwardly extending from a boundary of the bottom portion, the sidewall portion being inclined at an angle relative to the upper surface of the light guide plate.

13. The method of claim 12, wherein the forming of the first insulating patterns comprises:
forming a plurality of second photoresist patterns on the first insulating material layer to expose the portion of the first insulating material layer which is positioned above the upper surface of the first photoresist layer on the light guide plate;
performing a dry etching process using the second photoresist layer as an etch mask to remove the portion of the first insulating layer which is positioned above the upper surface of the first photoresist layer on the light guide plate; and
removing the second photoresist patterns to maintain the plurality of first insulating patterns on the upper surface of the light guide plate,
wherein to remove the portion of the first insulating layer which is positioned above the upper surface of the first photoresist layer on the light guide plate:
the first insulating material layer comprises a silicon nitride layer having a thickness of about 1 micrometer, and
the dry etching process is performed for about 120 seconds.

14. The method of claim 12, wherein
a refractive index of each of the first insulating patterns is higher than that of the light guide plate, and
a refractive index of the second insulating layer is lower than or equal to that of the light guide plate.

15. The method of claim 12, wherein
each of the first insulating patterns further comprises an inorganic material, and
the second insulating layer comprises an organic material.

16. The method of claim 12, wherein
the bottom portion of each of the first insulating patterns has a circular shape, the bottom portion defining a lower surface thereof at the upper surface of the light guide plate, and
the sidewall portion which upwardly extends from the boundary of the bottom portion defines an outer side surface thereof outwardly and slantingly extended from a boundary of the lower surface of the bottom portion.

17. The method of claim 16, wherein the outer side surface of the sidewall portion is inclined at an angle of about 60° to about 65° relative to the upper surface of the light guide plate.

18. The method of claim 16, wherein
the first insulating patterns are arranged in a matrix shape in a plane defined by first and second directions crossing each other, and
the lower surface of the bottom portion is parallel to the plane defined by the first and second directions.

19. The method of claim 18, wherein a maximum height from the lower surface of the bottom portion to an upper surface of the bottom portion in a direction normal to the lower surface of the bottom portion, a maximum width of the lower surface of the bottom portion in a direction parallel to the lower surface of the bottom portion, a maximum height from the lower surface of the bottom portion to an upper surface of the sidewall portion in the direction normal to the lower surface of the bottom portion, and a maximum distance between two adjacent bottom portions in the first or second direction satisfy a ratio relationship of 1:2:2:4-6.

20. A display device, comprising:
a display panel which displays an image using light; and
a backlight unit which generates the light and provides the light to the display panel,
wherein the backlight unit comprises:
a light source which generates the light;
a light guide plate which guides the light from the light source and emits guided light through an upper surface thereof toward the display panel;
a plurality of first insulating patterns on the upper surface of the light guide plate, into which the guided light from the upper surface of the light guide plate is incident, the first insulating patterns comprising an inorganic material; and
a second insulating layer which covers the first insulating patterns on the upper surface of the light guide plate to define an upper surface of the second insulating layer through which light exits toward the display panel, the second insulating layer comprising an organic material,
wherein each of the first insulating patterns comprises:
a bottom portion extended from the upper surface of the light guide plate, the bottom portion defining a lower surface thereof at the upper surface of the light guide plate; and
a sidewall portion upwardly extending from a boundary of the bottom portion, the sidewall portion being inclined at an angle relative to the upper surface of the light guide plate to define an outer side surface thereof outwardly and slantingly extended from a boundary of the lower surface of the bottom portion.
